(19) United States
(12) Patent Application Publication
(10) Pub. No.: US 2005/0161171 A1
(43) Pub. Date: Jul. 28, 2005

(54) Corded architectural covering including cord actuator and locking system

(76) Inventor: John A. Corey, Melrose, NY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/763,722

(22) Filed: Jan. 23, 2004

(51) Int. Cl. E06B 9/324

(52) U.S. Cl. 160/178.2

(57) ABSTRACT

An architectural covering is disclosed that includes at least one cord, a cord encapsulating member and a locking member connected to the cord. The locking member is selectively engaged with or disengaged from the cord encapsulating member to inhibit or permit movement, respectively, of the locking member and cord relative to the cord encapsulating member.

### BACKGROUND OF THE INVENTION

1. Field of the Invention

The present invention generally relates to architectural coverings and treatments. More particularly, the present invention relates to a corded architectural covering, such as a window shade, having a cord actuator and locking system for raising and lowering the window shade.

2. Description of the Related Art

Many types of architectural coverings and treatments such as Venetian-style blinds, cellular or pleated shades, and variants of these (herein represented without restriction merely by “architectural covering”), generally utilize one or more internal cords. In a particular architectural covering configuration, these cords are anchored to a lower rail and run upward through a shade or blind into an upper rail. Generally, more than one such cord is required in relatively wide architectural coverings to provide uniform and level support of the lower rail. The manipulable ends of the cords, which exit the upper rail through a locking mechanism, are typically joined with a tassel used by the operator to pull on the cords for raising and lowering the shade. Optionally, the cords exiting the upper rail may be joined together and affixed to a single extension cord and tassel using a coupling. This coupling is often referred to as an equalizer, because the multiple cords are knotted to the coupling during manufacture, giving a manufacturer an opportunity to adjust the effective length of each cord (by knot placement or otherwise) to ensure all cords equally share the load of the lower rail and hold the lower rail level.

In recent years, cases of accidental death and injury have been documented in which a person, typically a baby or small child, perhaps in playing with the exposed portion of the cords, becomes entangled in the cords. Of course, the exposed portion of the cords can be tied away from the reach of children, but that requires constant vigilance and effort by a user.

Recently, manufacturers have taken steps to reduce the risk of such injury. In one approach, a cord-joining member is connected to the cords adjacent to the cord locking mechanism when the cords are at their minimum exposure (i.e., when the shade is fully lowered and the cords are mostly within the shade). While the cord-joining member inhibits undesirable separation of the exposed cords when the shade is lowered, this approach is of little benefit when the shade is raised and the joined lift cords are fully exposed.

In another approach, the multiple lift cords are not joined, but merely fitted with individual tassels. Unfortunately, the individually tasseled cords can easily tangle or otherwise pose a danger to a child becoming entangled in the exposed portion of the cords. Less importantly, individually tasseled cords create unequal grip lengths that allow the lower rail and shade to hang unevenly.

A “cordless” approach has been offered by several manufacturers, in which the cords internal to the shade are wound on spools within the upper rail, assisted by retractor springs and clutches to allow the lifting and lowering of the shade by direct manipulation of the bottom rail. Such systems, though elegant in operation and relatively safe by virtue of having no exposed cords, nonetheless add significant cost to the architectural covering and require relatively larger upper rails to house the numerous components. Known “cordless” systems are also difficult to operate in architectural coverings where the range of motion of the lower rail is outside convenient operator reach (e.g., when the lower rail is near the floor or ceiling), or where the dimensions of the shade are too great for practically-sized retractor springs.

For these and other reasons, it is desirable to provide an improved corded architectural covering and approach for conveniently actuating the shade portion of the architectural covering without exposing the cords.

### SUMMARY OF THE INVENTION

An architectural covering is disclosed that includes at least one cord, a cord encapsulating member and a locking member connected to the cord. The locking member is selectively engaged with or disengaged from the cord encapsulating member to inhibit or permit movement, respectively, of the locking member and cord relative to the cord encapsulating member.

### BRIEF DESCRIPTION OF THE DRAWINGS

Embodiments of the invention will now be described, by way of example, with reference to the accompanying drawings, wherein:

FIG. 1 is a simplified elevational view of a prior art architectural covering that includes exposed cords used to raise and lower the shade portion of the architectural covering;

FIG. 2 is a partial elevational view of an architectural covering employing a cord actuator and locking system according to an embodiment of the present invention;

FIG. 3 is a partial elevational view of an architectural covering employing a cord actuator and locking system according to another embodiment of the present invention;

FIG. 4 is a cross-sectional view of the cord actuator and locking system of FIG. 2 taken along line 4-4;

FIG. 5 is a cross-sectional view of the cord actuator and locking system of FIG. 3 taken along line 5-5;

FIG. 6 is schematic diagram of the forces acting on a locking member employed in the cord actuator and locking system of FIG. 2;

FIG. 7 is schematic diagram of the forces acting on a locking member employed in the cord actuator and locking system of FIG. 3;

FIG. 8 is an enlarged view of the cord actuator and locking system shown in FIG. 2 during movement of the cords and locking mechanism; and

FIG. 9 is an enlarged view of the cord actuator and locking system shown in FIG. 3 during movement of the cords and locking mechanism.

### DETAILED DESCRIPTION

Referring now to the drawings, the preferred illustrative embodiments of the present invention are shown in detail. Although the drawings represent some preferred embodiments of the present invention, the drawings are not necessarily to scale and certain features may be exaggerated to better illustrate and explain the present invention. Further, the embodiments set forth herein are not intended to be exhaustive or otherwise limit or restrict the invention to the precise forms and configurations shown in the drawings and disclosed in the following detailed description.

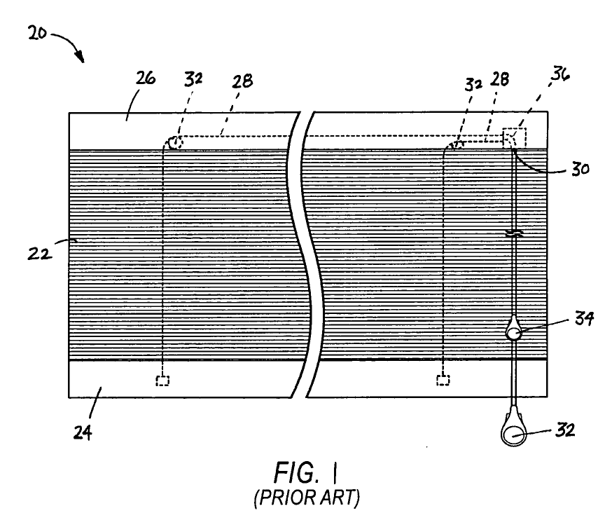

Referring to FIG. 1, a prior art architectural covering 20 is shown that includes a shade portion 22 supported along its lower edge by a lower rail 24 and along its upper edge by an upper rail 26. Covering 20 also includes cords 28 that enter upper rail 26 through an opening (proximate reference numeral 30) and then extend over pulleys or guides 32 and downwardly through shade portion 22 for secured engagement with lower rail 24. The exposed portion of cords 28 may be secured to a tassel 32 and include a cord-joining member 34, as shown in FIG. 1. Alternatively, covering 20 may include a coupling or “equalizer” for attaching an extension cord (none shown) to cords 28. A locking mechanism 36 is positioned proximate opening 30 to releasably engage cords 28 and hold lower rail 24 and shade portion 22 in the desired vertical position.

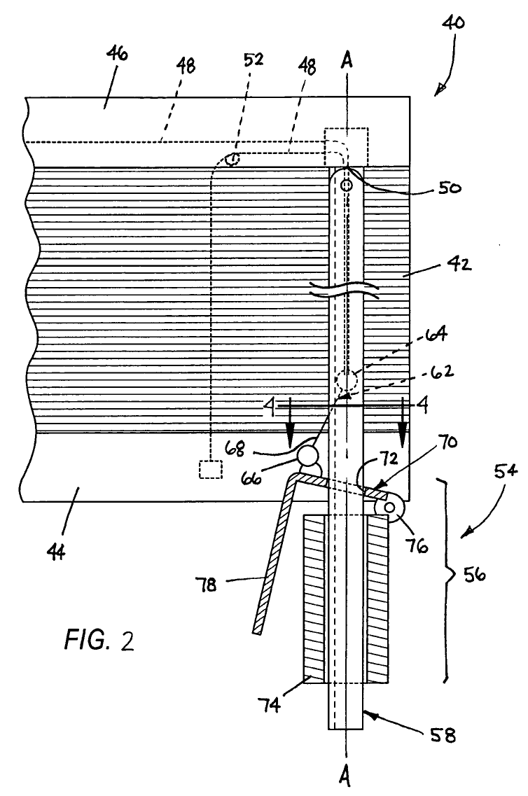

Referring to FIG. 2, an architectural covering 40 according to an embodiment of the present invention is shown. For illustration purposes, architectural covering 40 is shown as embodying a window covering. However, it will be appreciated that architectural covering 40 could be used for other purposes, such as on doors or to otherwise furnish the interior of dwellings.

In an embodiment of the invention, covering 40 includes a shade portion 42 that is supported along its lower edge by a lower rail 44 and along its upper edge by an upper rail 46. Shade portion 42 may comprise various types of view-through and adjustable configurations, including without limitation, Venetian-style blinds, cellular and pleated shades, and variants thereof. The terms “lower” and “upper” as used herein generally describe the relationship between rails 44 and 46, respectively, in the illustrated embodiment. However, the invention can be used with architectural covering that include other shade deployment modes, such as side-to-side deployment and other configurations that do not necessarily include an “upper” or “lower” rail.

One or more cords 48 extend into upper rail 46 through an opening (proximate reference numeral 50) and then over pulleys or guides 52 and downwardly through shade portion 42 for secured engagement with lower rail 44. The term “cords” should not be limited to the members shown in the drawings and may include various other types of support members, including without limitation, tapes, ribbons, chains and the like, provided these members are flexible and capable of supporting the weight of lower rail 44 and shade portion 42 without excessive stretch.

Unlike the prior art covering 20 described above, the manipulable ends of cords 48 are neither exposed nor engaged by a locking mechanism in upper rail 46. Rather, to enclose the manipulable end of cords 48 and control movement of lower rail 44, covering 40 includes a cord actuator and locking system 54. In the embodiment shown in FIG. 2, system 54 includes a locking mechanism 56 and a cord encapsulating member 58 that encloses cords 48 between upper rail 46 and locking mechanism 56. Cords 48 are fully contained within cord encapsulating member 58, even when lower rail 44 and shade portion 42 are fully raised, which eliminates the ability of cords 48 to entangle or otherwise form an entrapment loop. Unlike the prior art covering 20, locking mechanism 56 is relocated from a fixed position, typically within upper rail 46, to a new moveable position proximate an end of cords 48.

In a particular embodiment, cord encapsulating member 58 is an elongated, hollow wand that is pivotably suspended from upper rail 46 (or other fixed point proximate upper rail 46) close to opening 50. While opening 50 is located near one end of upper rail 46 in the illustrated embodiment, opening 50 and cord encapsulating member 58 may be positioned anywhere along the length of upper rail 46 that is convenient for an operator of covering 40.

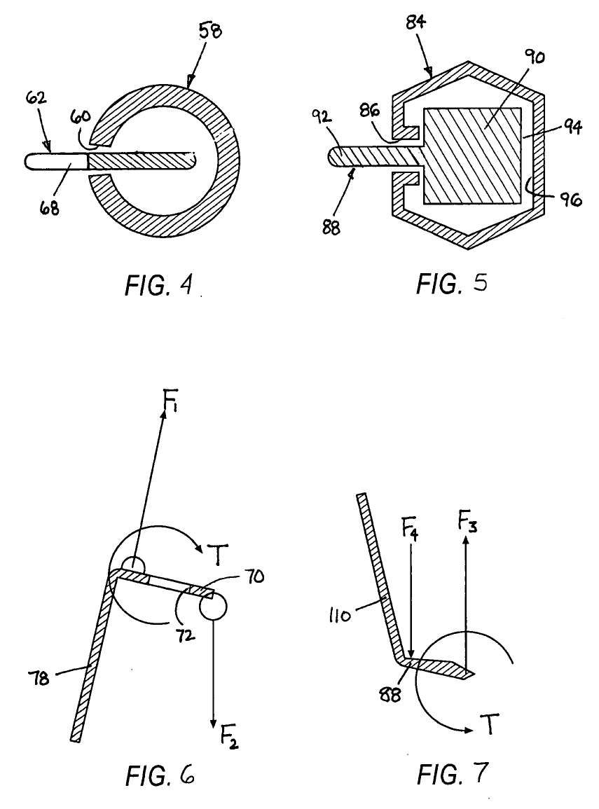

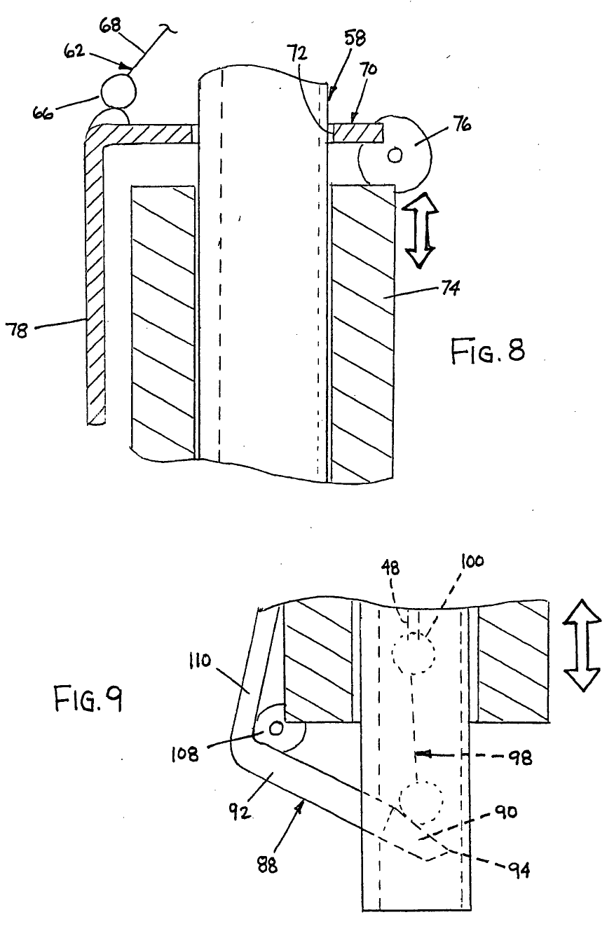

As shown in FIG. 4, cord encapsulating member 58 includes an elongated slot 60 along its length. Slot 60 is generally too narrow to allow passage of any one cord 48, but permits passage of a substantially rigid link 62, to which an end of each cord 28 is attached. In a particular embodiment, link 62 includes an upper connecting end 64, a lower connecting end 66 and an extension portion 68. Extension portion 68 is sized to pass through slot 60 and slide along the length of cord encapsulating member 58. Upper connecting end 64 is received within cord encapsulating member 58 and is connected to the enclosed and protected cord ends. In an example configuration, upper connecting end 64 comprises an eyelet around which the enclosed end of each cord 48 is tied.

Referring again to FIG. 2, lower connecting end 66 is pivotably connected to a locking member 70, which at least partially surrounds cord encapsulating member 58. In an embodiment, locking member 70 includes an aperture 72 through which cord encapsulating member 58 extends. Locking member 70 is pivotably attached to a moveable handle 74 by a pivot member 76, such as, for example, a hinge. Handle 74 is slidingly disposed over cord encapsulating member 58 for movement in a generally linear direction along an axis A-A. Optionally, locking member 70 may include a hand-adaptable extension 78, which allows an operator to move locking member 70 about pivot member 76 when extension 78 is gripped and pulled against handle 74.

Referring to FIGS. 2 and 6, the center of mass of locking member 70 is offset from axis A-A and the point of attachment of link 62 with cords 48. This offset induces a tilting in locking member 70 due to the torque (T) created between the generally upward force of cord tension (F₁) and the generally downward force of gravity (F₂) acting on handle 74. Locking member 70 and handle 74 are free to slide on cord encapsulating member 58 when locking member 70 is not tilted (see, e.g., FIG. 8), and are inhibited from sliding when locking member 70 tilts and binds against cord encapsulating member 58 (see, e.g., FIG. 2).

In use, gripping and pulling extension 78 against handle 74 removes the binding engagement between locking member 70 and cord encapsulating member 58, and enables locking mechanism 56 and cords 48 to rise along cord encapsulating member 58, thereby releasing cords 48 for movement through upper rail 46 in a controlled manner to lower shade portion 42. Unbinding locking member 70 from cord encapsulating member 58 also permits locking mechanism 56 to be pulled down cord encapsulating member 58, to accumulate additional cord length inside cord encapsulating member 58 and thereby raise shade portion 42. Alternatively or in combination with pulling extension 78 toward handle 74, an upwardly directed force may be applied to handle 74, which causes locking member 70 to pivot and unbind from cord encapsulating member 58.

Unlike the prior art covering 20, which use a locking mechanism 36 in upper rail 26 to inhibit movement of the cords, no direct cord pinching or cord drag is imposed on cords 48 in covering 40 of the present invention, reducing the likelihood of cord damage or breakage. Further, the present invention overcomes non-uniform gripping of multiple cords 28 in the prior art covering 20, which can cause the lower rail 24 and shade portion 22 to hang unevenly, by inhibiting movement of a single moveable member connected to the cords (i.e., link 62), rather than the cords themselves.

Although the torque required for binding locking member 70 with cord encapsulating member 58 is at least partially created by the weight of shade portion 42 and lower rail 44 (cord tension F₁), system 54 may be used with architectural coverings having other shade deployment modes, such as bottom-up or side-to-side deployment, provided some counterforce is applied to tension cords 48. Furthermore, while a tilting interface is illustrated and described for binding locking member 70 with cord encapsulating member 58, other suitable binding interfaces may also be used, including without limitation, sliding diagonals (e.g., binding interface similar to that used in bicycle handle attachments) or collet-type expansion elements (e.g., binding interface commonly used in machine tool grips).

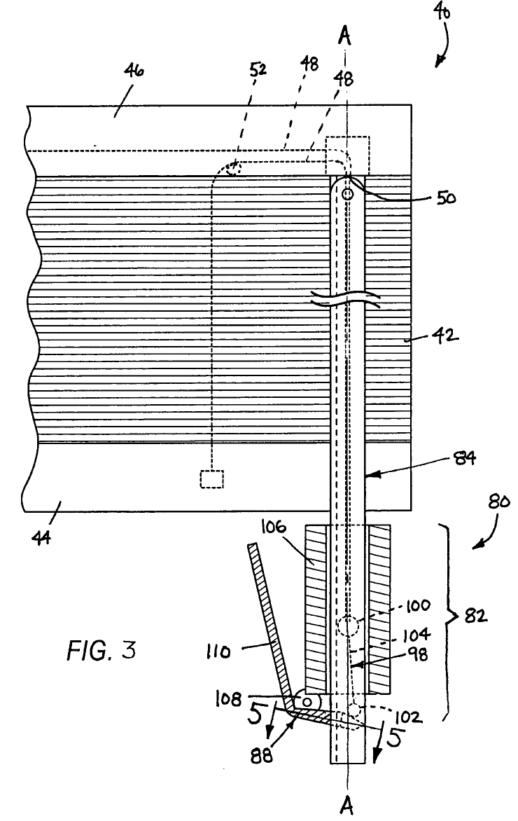

In another embodiment of the invention, the locking member can be configured to bind against an internal surface of the cord encapsulating member, rather than the exterior surface. In a representative embodiment shown in FIG. 3, a cord actuator and locking system 80 is provided that includes a locking mechanism 82 and a cord encapsulating member 84 that encloses cords 48 between upper rail 46 and locking mechanism 82.

In the embodiment illustrated in FIGS. 3 and 5, cord encapsulating member 84 includes a slot 86 that is generally too narrow to allow passage of any one cord 48, but permits passage of a locking member 88 into the interior of cord encapsulating member 84. Locking member 88 includes a binding portion 90 disposed within cord encapsulating member 84 and a connecting portion 92 that is connected to binding portion 90 and extends outwardly of cord encapsulating member 84 through slot 86. Binding portion 90 includes at least one binding edge 94 that selectively engages an interior surface of cord encapsulating member 84.

In a particular configuration, locking member 88 includes a generally rectangular binding portion 90 having at least one binding edge 94. Cord encapsulating member 84 exhibits a generally hexagonal cross-section having at least one interior surface 96 selectively engaged by binding edge 94. However, the cross-sections of locking member 88 and cord encapsulating member 84 are not limited the profiles illustrated in FIG. 5 and may include other cross-sectional profiles provided locking member 88 includes at least one binding edge 94 that engages an interior surface of cord encapsulating member 84.

Referring again to FIG. 3, locking mechanism 82 also includes a link 98 that is enclosed within cord encapsulating member 84. Link 98 includes an upper connecting end 100, a lower connecting end 102 and an extension portion 104. Upper connecting end 100 is connected to the enclosed and protected end of each cord 48. In an example configuration, upper connecting end 100 comprises an eyelet around which the enclosed end of each cord 48 is tied. Lower connecting end 102 is pivotably connected to locking member 88 within cord encapsulating member 84.

Locking member 88 is pivotably attached to a moveable handle 106 by a pivot member 108, such as, for example, a hinge. Handle 106 is slidingly disposed on cord encapsulating member 84 for movement in a generally linear direction along an axis A-A. A hand-adaptable extension 110 extends from locking member 88, which allows a user to unbind locking member 88 from cord encapsulating member 84 when extension 110 is gripped and pulled against handle 106.

Referring to FIGS. 3 and 7, the center of mass of locking member 88 is offset from axis A-A and the point of cord attachment between link 98 and cords 48. This offset induces a tilting in locking member 88 due to the torque (T) created between the generally upward force of cord tension (F₃) and the generally downward force of gravity (F₄) acting on handle 106. Locking member 88 and handle 106 are free to slide on cord encapsulating member 84 when extension is pulled toward handle 106 (see, e.g., FIG. 9), and are inhibited from sliding when locking member 88 binds against interior surface 96 of cord encapsulating member 84 (see, e.g., FIG. 3).

Although the embodiments described above are directed toward a cord encapsulating member that extends vertically downward from an upper rail of the architectural covering, it will be appreciated that the function of the cord encapsulating member may be achieved in a non-vertical manner. For example, the upper rail of an architectural covering may include a substantially horizontal cord encapsulating member integrally formed therewith and having a moveable locking mechanism disposed thereon for controlling movement of the lift cords.

The cord actuator and locking system of the present invention is described for use with, among other architectural coverings, cellular or pleated shades that include one or more lift cords. For Venetian-style coverings or other architectural coverings that include one or more tilter cords, a second cord actuator and locking system may be employed to actuate the tilter cords.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1. An architectural covering comprising:
at least one cord having a free end that is moveable to adjust the position or condition of the architectural covering;
a cord encapsulating member; and
a locking member connected to the free end of the cord and moveable with the free end during adjustment of the architectural covering, the locking member being normally engaged with the cord encapsulating member to prevent movement of the locking member and the cord relative to the cord encapsulating member, and the locking member being selectively releasable from the cord encapsulating member to permit movement of the cord and locking member relative to the encapsulating member.

2. The architectural covering of claim 1, further including a handle moveably disposed on the cord encapsulating member.

3. The architectural covering of claim 2, wherein the locking member is moveably attached to the handle.

4. The architectural covering of claim 1, wherein the locking member includes a hand-actuatable extension.

5. The architectural covering of claim 1, wherein the cord encapsulating member is an elongated wand.

6. The architectural covering of claim 1, wherein the cord encapsulating member includes a slot.

7. The architectural covering of claim 6, furthering including a link connecting the cord to the locking member.

8. The architectural covering of claim 7, wherein the link extends through the slot.

9. The architectural covering of claim 1, wherein the locking member is selectively engaged with or disengaged from an interior surface of the cord encapsulating member.

10. The architectural covering of claim 1, wherein the locking member is selectively engaged with or disengaged from an exterior surface of the cord encapsulating member.

11-20. (canceled)

21. An architectural covering having a first fixed rail, a second movable rail, a shade portion, at least one cord extending through the fixed rail and secured to the movable rail for adjusting the position of the movable rail, and a cord actuator and locking system comprising:
a cord encapsulating member; and
a locking member connected to the free end of the cord and moveable with the free end during adjustment of the position of the moveable rail, the locking member being normally engaged with the cord encapsulating member to prevent movement of the locking member and the cord relative to the cord encapsulating member, and the locking member being selectively releasable from the cord encapsulating member to permit movement of the cord and locking member relative to the encapsulating member.

22. The covering of claim 21, wherein the cord encapsulating member is pivotably attached to the upper rail.

23. The covering of claim 21, wherein the cord encapsulating member is integrally formed with the upper rail.

24. The architectural covering of claim 1 wherein the weight of the covering creates tension in the cord, and said tension creates a force normally maintaining the locking, member in movement-preventing engagement with the cord encapsulating member.

25. The architectural covering of claim 21 wherein the weight of the covering creates tension in the cord, and said tension creates a force normally maintaining the locking member in movement-preventing engagement with the cord encapsulating member.
